(19) United States
(12) Patent Application Publication
(10) Pub. No.: US 2014/0170468 A1
(43) Pub. Date: Jun. 19, 2014

(54) BATTERY MODULE

(71) Applicant: Tomoharu Sasaoka, Hadano-shi (JP)

(72) Inventor: Tomoharu Sasaoka, Hadano-shi (JP)

(73) Assignee: TOYOTA JIDOSHA KABUSHIKI KAISHA, Toyota-shi, Aichi (JP)

(21) Appl. No.: 14/131,523

(22) PCT Filed: Jul. 13, 2011
(86) PCT No.: PCT/JP2011/065970

§ 371 Date: Jan. 8, 2014

(51) Int. Cl. H01M 2/10

(52) U.S. Cl. CPC H01M 2/1094; H01M 2/1061
USPC 429/153

(57) ABSTRACT

A battery module which has a structure that can apply an approximately uniform pressure to electrodes contained in the battery module. A battery module including two or more unit cells and a hermetically closed housing for housing the two or more unit cells and a fluid, each unit cell including one or more stack units and a cell case for housing the one or more stack units, each stack unit including at least a positive electrode, an electrolyte layer and a negative electrode stacked together, wherein the two or more unit cells are stacked in a direction that is substantially the same as a stacking direction of the one or more stack units, and wherein a gap member is present between the stacked unit cells, the gap member being configured to allow the fluid to flow into the gap member.

### TECHNICAL FIELD

The present invention relates to a battery module having a structure that can apply an approximately uniform pressure to electrodes contained in the module.

### BACKGROUND ART

A secondary battery is a battery that is able to convert chemical energy decrease, which is associated with chemical reaction, into electrical energy and discharge the energy. Moreover, it is also a battery that is able to convert electrical energy into chemical energy and store (charge) the chemical energy, by passing electrical current in a direction that is opposite to the direction of current at the time of discharge. Of secondary batteries, a lithium secondary battery has high energy density, so that it is widely used as a power source for laptop personal computers, cellular phones, etc.

In a lithium secondary battery, when graphite (C) is used as a negative electrode active material, a reaction described by the following formula (I) proceeds at the negative electrode, upon discharge:

LiₓC→C+xLi⁺+xe⁻ (I)

wherein 0<x<1.

Electrons generated by the reaction of the formula (I) pass through an external circuit, work by an external load, and then reach the positive electrode. Lithium ions (Li⁺) generated by the reaction of the formula (I) are transferred by electro-osmosis from the negative electrode side to the positive electrode side through an electrolyte sandwiched between the negative electrode and the positive electrode.

When lithium cobaltate (Li₁₋ₓCoO₂) is used as a positive electrode active material, a reaction described by the following formula (II) proceeds at the positive electrode, upon discharge:

Li₁₋ₓCoO₂+xLi⁺+xe⁻→LiCoO₂ (II)

wherein 0<x<1.

Upon charging the battery, reactions which are reverse to the reactions described by the above formulae (I) and (II) proceed at the negative electrode and the positive electrode. At the negative electrode, graphite in which lithium has been intercalated by graphite intercalation (LiₓC) becomes reusable, while lithium cobaltate (Li₁₋ₓCoO₂) is regenerated at the positive electrode. Because of this, discharge becomes possible again.

Electrolytes that are generally used for lithium secondary batteries, such as a liquid electrolyte obtained by dissolving lithium salt in organic solvent, have very small electroconductivity. The electroconductivity of the liquid electrolyte is about a fortieth part of the electroconductivity of aqueous solution-based liquid electrolytes that are used for nickel-cadmium secondary batteries, etc. In lithium secondary batteries, accordingly, there is an increase in internal resistance and results in heavy load characteristics and low temperature characteristics that are inferior to those of batteries using aqueous solution-based liquid electrolytes; moreover, there are problems such as heat generation and result in an obstacle to increasing battery size.

To decrease the internal resistance of lithium secondary batteries, it has been proposed to apply pressure to a stack of electrodes, which constitutes a battery. As a technique that uses such a stack pressurization, a lithium secondary battery-related technique is disclosed in Patent Literature 1, which is such a technique that in an assembled battery in which unit cells are combined and housed in an assembled-battery case, the unit cells each comprising a negative electrode, a positive electrode, a non-aqueous liquid electrolyte and a case for housing them, the unit cells are pressurized with a hydrostatic pressure that is generated inside the assembled-battery case by filling a gas, a liquid, a solid powder or a mixture thereof into the space inside the assembled-battery case but outside the unit cell cases.

### Citation List

Patent Literature 1: Japanese Patent Application Laid-Open No. H10-214638

### SUMMARY OF INVENTION

### Technical Problem

A method for pressurizing unit cells is disclosed in paragraph [0029] of the Specification of Patent Literature 1, which is such a method that unit cells housed in an assembled-battery case are pressurized by filling argon gas into the battery case. However, by such a method, it is difficult to uniformly pressurize all electrodes in the unit cells.

The present invention was achieved in light of the above circumstance. An object of the present invention is to provide a battery module having a structure that can apply an approximately uniform pressure to electrodes contained in the module.

### Solution to Problem

The battery module of the present invention comprises two or more unit cells and a hermetically closed housing for housing the two or more unit cells and a fluid, each unit cell comprising one or more stack units and a cell case for housing the one or more stack units, each stack unit comprising at least a positive electrode, an electrolyte layer and a negative electrode stacked together, wherein the two or more unit cells are stacked in a direction that is substantially the same as a stacking direction of the one or more stack units, and wherein a gap member is present between the stacked unit cells, the gap member being configured to allow the fluid to flow into the gap member.

In the present invention, the gap member can be at least one selected from the group consisting of a porous body, a woven fabric, a non-woven fabric and a member having a groove.

In the present invention, preferably, the number of the stack units in each unit cell is one to three.

In the present invention, preferably, the fluid is pressurized to have a pressure equal to or more than the atmospheric pressure.

In the present invention, preferably, the fluid is a gas.

### Advantageous Effects of Invention

According to the present invention, by providing a gap member between unit cells, a space into which a fluid can flow can be readily secured. Therefore, according to the present invention, the unit cells can be uniformly pressurized by the fluid flowing into the gap member.

### BRIEF DESCRIPTION OF DRAWINGS

FIG. 1 is a view showing a first typical example of the battery module according the present invention, and it is also a schematic sectional view taken in a stacking direction.

FIG. 2 is a view showing a second typical example of the battery module according the present invention, and it is also a schematic sectional view taken in a stacking direction.

FIG. 3 is a view showing an example of a conventional battery module structure comprising two or more unit cells, and it is also a schematic sectional view taken in a stacking direction.

FIG. 4 is a schematic sectional view of a conventional battery module, showing pressure directions applied to unit cells by a fluid.

### DESCRIPTION OF EMBODIMENTS

The battery module of the present invention comprises two or more unit cells and a hermetically closed housing for housing the two or more unit cells and a fluid, each unit cell comprising one or more stack units and a cell case for housing the one or more stack units, each stack unit comprising at least a positive electrode, an electrolyte layer and a negative electrode stacked together, wherein the two or more unit cells are stacked in a direction that is substantially the same as a stacking direction of the one or more stack units, and wherein a gap member is present between the stacked unit cells, the gap member being configured to allow the fluid to flow into the gap member.

In a battery, especially in a solid battery comprising a solid electrolyte, it is known that a pressure applied to electrodes has great influence on charge-discharge performance. By mechanical pressure-applying methods such as a method of pressurizing a stack of electrodes in the electrode-stacking direction, it has been difficult to apply a uniform pressure to the electrodes or to apply a stable pressure over time.

Meanwhile, in the case of pressure applying methods using a fluid, such as the method as disclosed in Patent Literature 1, there is a problem of non-uniform surface pressure distribution due to a difference in electrode thickness, etc., especially in the case of a stack-type battery module comprising multiple unit cells stacked.

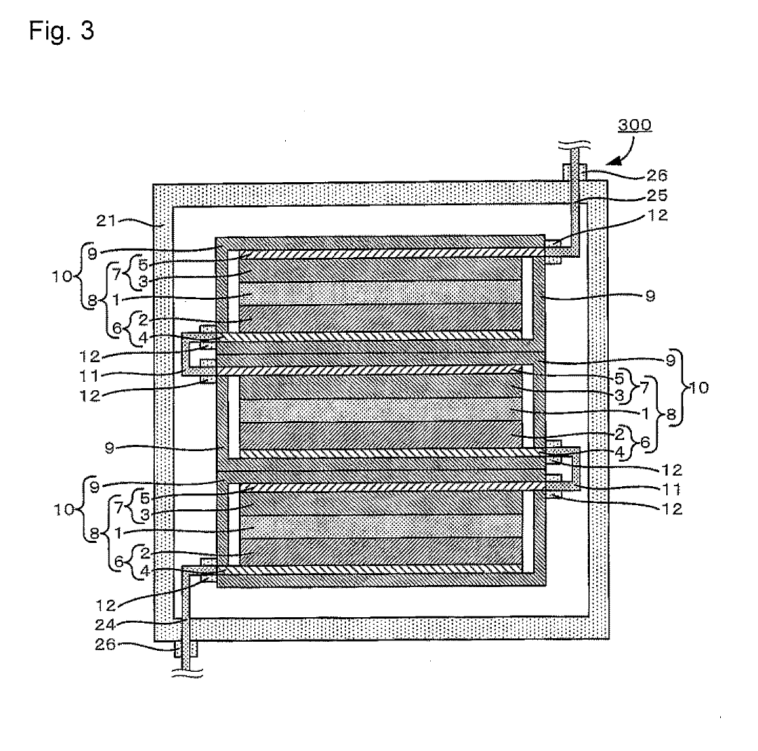

FIG. 3 is a view showing an example of a conventional battery module structure comprising two or more unit cells, and it is also a schematic sectional view taken in a stacking direction. Each double wavy line shown in the figure means that a part of the figure is omitted.

As shown in FIG. 3, a positive electrode 6, an electrolyte layer 1 and a negative electrode 7 are stacked to constitute each stack unit 8. The positive electrode 6 is composed of a positive electrode active material layer 2 and a positive electrode current collector 4. The negative electrode 7 is composed of a negative electrode active material layer 3 and a negative electrode current collector 5. The stack unit 8 is housed in a cell case 9 to constitute each unit cell 10.

The unit cells 10 are stacked in a direction that is approximately the same as the stacking direction of the components of each stack unit. The positive electrode current collector 4 of each unit cell is connected to the negative electrode current collector 5 of each adjacent unit cell via a lead 11. From the viewpoint of keeping the inside of the cell case 9 airtight, both bases of the lead 11 are sealed with a sealing material 12. The unit cells are housed in a housing 21, and the gap between the housing 21 and the unit cells 10 is filled with a fluid (not shown). A positive electrode lead 24 and a negative electrode lead 25 are respectively connected to the positive electrode current collector 4 and the negative electrode current collector 5, the collectors being situated at the ends of the stack of the series-connected unit cells. A part of each lead extends to the outside of the housing 21. From the viewpoint of keeping the inside of the housing 21 airtight, a base of the positive electrode lead 24 and that of the negative electrode lead 25 are sealed with a sealing material 26.

That is, a conventional battery module 300 shown in FIG. 3 is such a battery module that the fluid and a monopolar battery comprising the unit cells 10 are housed in the housing 21, the three unit cells being connected in series.

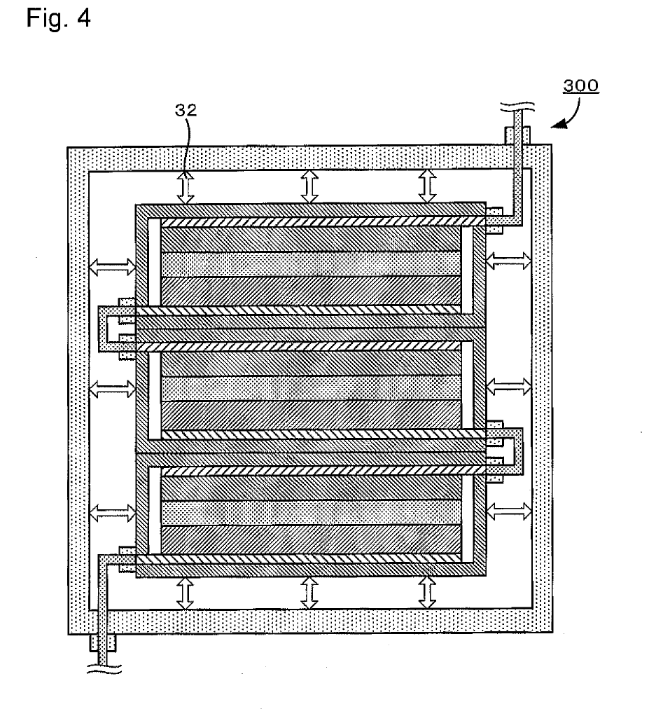

FIG. 4 is a schematic sectional view of a conventional battery module, showing pressure directions applied to unit cells by a fluid. Each double-headed arrow 32 shows pressure directions applied by the fluid.

As shown in FIG. 4, in a battery module in which unit cells are just stacked and housed in a housing and the inside of the housing is filled with a fluid, such as a conventional battery module, the stacked unit cells are merely pressurized from the outermost side thereof. Therefore, on the electrode surfaces of the stack units, non-uniform surface pressure distribution occurs due to a difference in electrode thickness and due to a difference in electrode surface condition, electrode surface roughness, etc. Occurrence of non-uniform surface pressure distribution is not preferable because charge-discharge performance of the battery is changed due to the surface pressure applied to the electrodes. For example, when the surface pressure is lower than a predetermined pressure, the resistance inside the battery may increase. When the surface pressure is higher than a predetermined pressure, there may be a decrease in battery durability.

As a result of diligent researches, the inventor of the present invention has found that in a battery module in which electrodes are pressurized by a fluid, a uniform pressure can be applied to the electrodes and the performance and durability of the battery can be increased by providing a gap member between unit cells and allowing the fluid to mainly flow into the gap member. Based on this finding, the inventor has accomplished the present invention.

In the present invention, it is needed that the stacking direction of the components of each stack unit is approximately the same as the stacking direction of the unit cells and the gap members. As just described, by aligning the stacking direction of the components of each stack unit with the stacking direction of the unit cells and the gap members, it is possible to highly simplify the battery module structure to obtain the effect of applying a uniform pressure to electrodes, and it is thus possible to reduce the volume of the whole battery module.

The stack unit used in the present invention can be a wound product obtained by winding a stack composed of a positive electrode, an electrolyte layer and a negative electrode. When the wound product is used as the stack unit, “stacking direction of the components of each wound product” means all directions perpendicular to the winding axis.

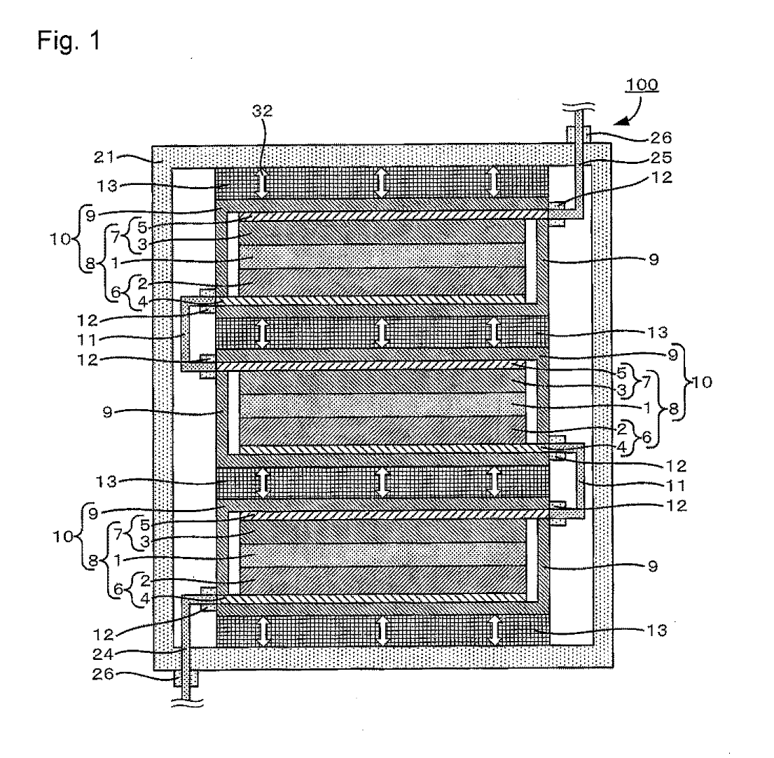

FIG. 1 is a view showing a first typical example of the battery module according the present invention, and it is also a schematic sectional view taken in a stacking direction. Each double wavy line shown in the figure means that a part of the figure is omitted.

As shown in FIG. 1, a positive electrode 6, an electrolyte layer 1 and a negative electrode 7 are stacked to constitute each stack unit 8. The positive electrode 6 is composed of a positive electrode active material layer 2 and a positive electrode current collector 4. The negative electrode 7 is composed of a negative electrode active material layer 3 and a negative electrode current collector S. The stack unit 8 is housed in a cell case 9 to constitute each unit cell 10.

The unit cells 10 are stacked in a direction that is approximately the same as the stacking direction of the components of each stack unit. The positive electrode current collector 4 of each unit cell is connected to the negative electrode current collector 5 of each adjacent unit cell via a lead 11. From the viewpoint of keeping the inside of the cell case 9 airtight, both bases of the lead 11 are sealed with a sealing material 12.

In the first typical example 100, moreover, a gap member is present between the stacked unit cells 10, which is configured to flow a fluid thereinto. The thickness and area of the gap member are not particularly limited, as long as it can provide a gap between the two unit cells, which allows the fluid to sufficiently flow thereinto. Details of the gap member will be described below.

The unit cells 10, the fluid (not shown) and the gap members 13 are housed in a housing 21. The fluid flows into the gap members 13. A positive electrode lead 24 and a negative electrode lead 25 are respectively connected to the positive electrode current collector 4 and the negative electrode current collector 5, the collectors being situated at the ends of the stack of the series-connected unit cells. A part of each lead extends to the outside of the housing 21. From the viewpoint of keeping the inside of the housing 21 airtight, a base of the positive electrode lead 24 and that of the negative electrode lead 25 are sealed with a sealing material 26.

Each double-headed arrow 32 shown in FIG. 1 shows pressure directions applied by the fluid. As shown in FIG. 1, in the first typical example 100, non-uniform surface pressure distribution is minimized by applying pressure to each unit cell 10 from both sides of the stacking direction. Therefore, it is possible to decrease the resistance inside the cell and to increase the cell durability.

Also in the first typical example 100, by the fluid flowing into the gap members 13, pressure can be efficiently and uniformly applied to the unit cells, regardless of the amount of fluid filled into the housing 21, without the possibility of partial distribution of the fluid in the housing 21 or the possibility of pressurizing the unit cells from undesirable directions.

The number of the stack units in each unit cell is not particularly limited. However, from the viewpoint of uniformly and sufficiently pressurizing the stack units, the number of the stack units in each unit cell is preferably one to three. When the number is four or more, there may be a difference in the pressure applied to the stack units in each unit cell.

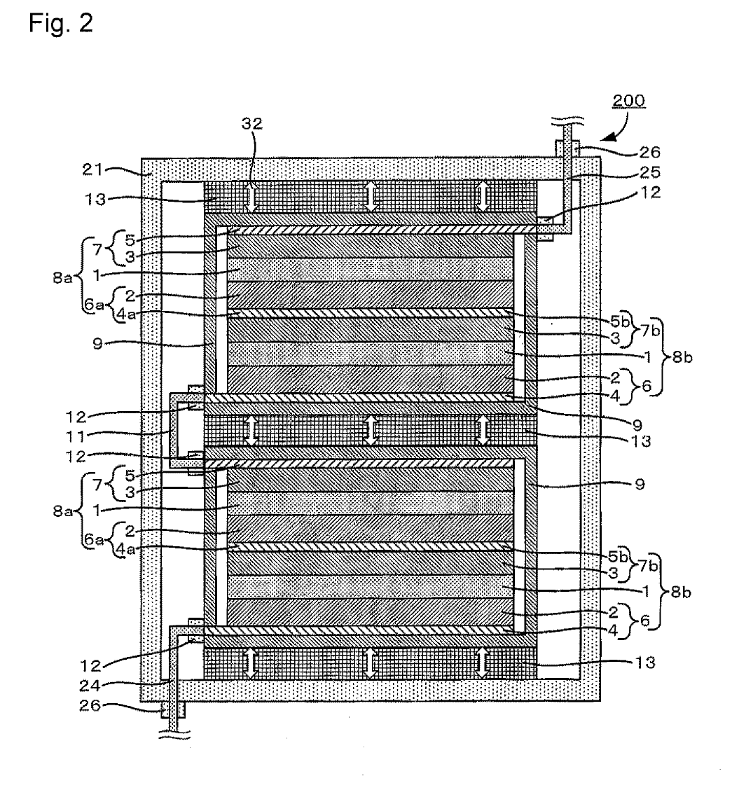

FIG. 2 is a view showing a second typical example of the battery module according the present invention, and it is also a schematic sectional view taken in a stacking direction. Each double wavy line shown in the figure means that a part of the figure is omitted.

As shown in FIG. 2, a positive electrode 6a, an electrolyte layer 1 and a negative electrode 7 are stacked to constitute each stack unit 8a. The positive electrode 6a is composed of a positive electrode active material layer 2 and a positive electrode current collector 4a. The negative electrode 7 is composed of a negative electrode active material layer 3 and a negative electrode current collector 5.

As shown in FIG. 2, a positive electrode 6, an electrolyte layer 1 and a negative electrode 7b are stacked to constitute each stack unit 8b. The positive electrode 6 is composed of a positive electrode active material layer 2 and a positive electrode current collector 4. The negative electrode 7b is composed of a negative electrode active material layer 3 and a negative electrode current collector 5b.

In the second typical example 200, the stack units 8a and 8b are housed in a cell case 9 to constitute each unit cell. The stack units 8a and 8b can share an electrode current collector of the other. In particular, as shown in FIG. 2, the positive electrode current collector 4a of the stack unit 8a can be the negative electrode current collector 5b of the stack unit 8b.

The unit cells are stacked in a direction that is approximately the same as the stacking direction of the components of each stack unit. A lead 11 and a sealing material 12 are the same as those of the first typical example.

In the second typical example 200, like the first typical example 100, a gap member 13 is present between the stacked unit cells, which is configured to flow a fluid thereinto. The unit cells, the fluid (not shown) and the gap members 13 are housed in a housing 21. The fluid flows into the gap members 13. A positive electrode lead 24, a negative electrode lead 25 and a sealing material 26 are the same as those of the first typical example 100.

Each double-headed arrow 32 shown in FIG. 2 means the same as that of FIG. 1. As shown in FIG. 2, in the second typical example 200, like the first typical example 100, non-uniform surface pressure distribution is minimized. Therefore, it is possible to decrease the resistance inside the cell and to increase the cell durability. Also, as shown in FIG. 2, in the second typical example 200, like the first typical example 100, pressure can be efficiently and uniformly applied to the unit cells, regardless of the amount of fluid filled into the housing 21.

The embodiment of present invention is not limited to the first and second typical examples. The two typical examples are each a monopolar battery module in which unit cells are connected in series. However, it can be a bipolar battery module in which unit cells are connected in parallel, or can be a combination of monopolar and bipolar battery modules. That is, the embodiment of electrical connection between unit cells is not particularly limited, as long as the gap member is present between unit cells.

Hereinafter, the components used in the battery module of the present invention will be described, which include the positive electrode, the negative electrode, the electrolyte layer, the stack unit, the cell case, the gap member, the fluid, the housing, and other members that are suitably used in the battery module of the present invention, such as a separator.

### (Positive Electrode)

The positive electrode used in the present invention preferably comprises a positive electrode current collector and a positive electrode tab that is connected to the positive electrode current collector. More preferably, the positive electrode further comprises a positive electrode active material layer containing a positive electrode active material.

Concrete examples of positive electrode active materials that can be used in the present invention include Ni, LiCoO₂, LiNi_{1/3}Mn_{1/3}Co_{1/3}O₂, LiNiPO₄, LiMnPO₄, LiNiO₂, LiMn₂O₄, LiCoMnO₄, Li₂NiMn₃O₈, Li₃Fe₂(PO₄)₃ and Li₃V₂ (PO₄)₃. Fine particles comprising a positive electrode active material can be covered with LiNbO₃ or the like.

Of these materials, in the present invention, it is preferable to use LiCoO₂ as the positive electrode active material.

The thickness of the positive electrode active material layer used in the present invention varies depending on the intended use of the battery module, etc. However, the thickness is preferably in the range of 5 to 250 μm, more preferably in the range of 20 to 200 μm, still more preferably in the range of 30 to 150 μm.

The average particle diameter of the positive electrode active material is, for example, preferably in the range of 1 to 50 μm, more preferably in the range of 1 to 20 μm, particularly preferably in the range of 3 to 5 μm. When the average particle diameter of the positive electrode active material is too small, there is a possibility of poor handling properties. When the average particle diameter of the positive electrode active material is too large, there may be a difficulty in obtaining a flat positive electrode active material layer. The average particle diameter of the positive electrode active material can be obtained by, for example, measuring the particle diameters of active material carrier particles observed with a scanning electron microscope (SEM) and averaging the particle diameters.

As needed, the positive electrode active material layer can contain an electroconductive material, a binder, etc.

The electroconductive material that the positive electrode active material layer used in the present invention has, is not particularly limited as long as it can increase the electroconductivity of the positive electrode active material layer. The examples include carbon blacks such as acetylene black, Ketjen Black and VGCF. The content of the electroconductive material in the positive electrode active material layer varies depending on the type of the electroconductive material; however, it is generally in the range of 1 to 10% by mass.

As the binder that the positive electrode active material layer used in the present invention has, for example, there may be mentioned synthetic rubbers such as styrene-butadiene rubber, ethylene-propylene rubber and styrene-ethylene-butadiene rubber; and fluorine polymers such as polyvinylidene fluoride (PVDF) and polytetrafluoroethylene (PTFE). The content of the binder in the positive electrode active material layer is required to be a content which allows the positive electrode active material and so on to be fixed, and is preferably as small as possible. The content of the binder is generally in the range of 1 to 10% by mass.

The positive electrode current collector used in the present invention is not particularly limited, as long as it functions to collect current from the positive electrode active material layer. Examples of materials for the positive electrode current collector include aluminum, aluminum alloy, stainless-steel, nickel, iron and titanium, and preferred are aluminum, aluminum alloy and stainless-steel. Examples of the form of the positive electrode current collector include a foil form, a plate form and a mesh form. Preferred is a foil form.

The positive electrode tab is a member for connecting the positive electrode current collector with leads and/or external loads outside the cell. The positive electrode tab is not particularly limited, as long as it is made of any of the same materials as those of the above-described positive electrode current collector. Examples of the materials for the positive electrode tab include aluminum, aluminum alloy and stainless-steel.

From the viewpoint of increased sealing properties, a dedicated sealing material can be used for the seal tab of the positive electrode tab and for the sealing part of the below-described cell case. Examples of the dedicated sealing material include commodity polymers such as polypropylene. There may be used a commercially-available tab lead (manufactured by Sumitomo Electric Industries, Ltd.) which is an integrated combination of positive electrode tab and seal.

The method for producing the positive electrode used in the present invention is not particularly limited, as long as it can provide the above-described positive electrode. After forming the positive electrode active material layer, the layer can be pressed to increase the electrode density.

### (Negative Electrode)

The negative electrode used in the present invention preferably comprises a negative electrode current collector and a negative electrode tab connected to the negative electrode current collector. More preferably, the negative electrode further comprises a negative electrode active material layer comprising a negative electrode active material.

The negative electrode active material used for the negative electrode active material layer is not particularly limited, as long as it can store/release metal ions. In the case of using lithium ions as the metal ions, for example, there may be mentioned lithium metal, lithium alloy, metal oxides such as lithium titanate, metal sulfides, metal nitrides and carbonaceous materials such as graphite, soft carbon and hard carbon. The negative electrode active material can be in a powder form or a thin film form.

As needed, the negative electrode active material layer can contain an electroconductive material, a binder, etc.

As the binder and electroconductive material that can be contained in the negative electrode active material layer, there may be used those mentioned above. It is preferable to appropriately select the amount of the binder and electroconductive material used, depending on the intended application, etc., of a solid sulfide battery module. The thickness of the negative electrode active material layer is not particularly limited. However, for example, it is preferably in the range of 5 to 150 μm, more preferably in the range of 10 to 80 μm.

The negative electrode current collector used in ₜhe present invention is not particularly limited, as long as it functions to collect current from the negative electrode active material layer.

Examples of materials for the negative electrode current collector include nickel, copper and stainless-steel. Examples of the form of the negative electrode current collector include a foil form, a plate form and a mesh form. Preferred is a foil form.

The negative electrode tab is a member for connecting the negative electrode current collector with leads and/or external loads outside the cell. The negative electrode tab is not particularly limited, as long as it is made of any of the same materials as those of the above-described negative electrode current collector. Examples of the materials for the negative electrode tab include nickel, copper and stainless-steel.

The negative electrode tab is similar to the positive electrode tab in that a dedicated sealing material can be used and that a tab lead can be used, which is an integrated combination of negative electrode tab and seal.

As the method for producing the negative electrode used in the present invention, there may be used a method that is similar to the above-described positive electrode production method.

The positive electrode and/or negative electrode used in the present invention can contain electrolytes such as a liquid electrolyte, a gel electrolyte and a solid electrolyte, all of which will be described below.

### (Electrolyte Layer)

The electrolyte layer used in the present invention is sandwiched between the positive electrode active material layer and the negative electrode active material layer and functions to exchange metal ions between the layers.

Liquid, gel and solid electrolytes, etc., can be used to form the electrolyte layer. They may be used alone or in combination of two or more kinds.

As the liquid electrolyte, there may be used a non-aqueous liquid electrolyte and an aqueous liquid electrolyte.

It is preferable to appropriately select the type of the non-aqueous liquid electrolyte, depending on the type of metal ions to be conducted. For example, in general, the non-aqueous liquid electrolyte used for lithium secondary batteries can contain a lithium salt and a non-aqueous solvent. Examples of the lithium salt include inorganic lithium salts such as LiPF₆, LiBF₄, LiClO₄ and LiAsF₆; and organic lithium salts such as LiCF₃SO₃, LiN(SO₂CF₃)₂ (Li-TFSI), LiN SO₂C₂F₅)₂ and LiC(SO₂CF₃)₃. Examples of the non-aqueous solvent include ethylene carbonate (EC), propylene carbonate (PC), dimethyl carbonate (DMC), diethyl carbonate (DEC), ethyl methyl carbonate (EMC), ethyl carbonate, butylene carbonate, γ-butyrolactone, sulfolane, acetonitrile (AcN), dimethoxymethane, 1,2-dimethoxyethane (DME), 1,3-dimethoxypropane, diethyl ether, tetraethylene glycol dimethyl ether (TEGDME), tetrahydrofuran, 2-methyltetrahydrofuran, dimethylsulfoxide (DMSO) and mixtures thereof. The concentration of the lithium salt in the non-aqueous liquid electrolyte is in the range of 0.5 to 3 mol/L, for example.

In the present invention, a low-volatile liquid can be used as the non-aqueous liquid electrolyte or as the non-aqueous solvent. Examples thereof include ionic liquids as typified by N-methyl-N-propylpiperidinium bis(trifluoromethanesulfonyl)imide (PP13TFSI), N-methyl-N-propylpyrrolidinium bis(trifluoromethanesulfonyl)imide (P13TFSI), N-butyl-N-methylpyrrolidinium bis(trifluoromethanesulfonyl)imide (P14TESI), N,N-diethyl-N-methyl-N-(2-methoxyethyl)ammonium bis(trifluoromethanesulfonyl)imide (DEMETFSI) and N,N,N-trimethyl-N-propylammonium bis(trifluoromethanesulfonyl)imide (TMPATFSI).

It is preferable to appropriately select the type of the aqueous liquid electrolyte, depending on the type of metal ions to be conducted. For example, in lithium secondary batteries, an aqueous liquid electrolyte containing a lithium salt and water is generally used. Examples of the lithium salt include LiOH, LiCl, LiNO₃ and CH₃CO₂Li.

The gel electrolyte used in the present invention is generally one obtained by adding a polymer to a non-aqueous liquid electrolyte for gelation. For example, a non-aqueous gel electrolyte for lithium secondary batteries can be obtained by adding a polymer such as polyethylene oxide, polypropylene oxide, polyacrylonitrile, polyvinylidene fluoride (PVDF), polyurethane, polyacrylate or cellulose to the above-described non-aqueous liquid electrolyte for gelation. In the present invention, preferred is a non-aqueous gel electrolyte containing LiTFSI(LiN(CF₃ SO₂)₂)-PEO.

As the solid electrolyte, there may be used a sulfide solid electrolyte, an oxide solid electrolyte, a polymer electrolyte, etc. Also, there may be used crystals of these materials.

Concrete examples of sulfide solid electrolytes include Li₂S—P₂S₅, Li₂S—P₂S₃, Li₂S—P₂S₃—P₂S₅, Li₂S—SiS₂, Li₂S—Si₂S, Li₂S—B₂S₃, Li₂S-GeS₂, LiI—Li₂S—P₂S₅, LiI—Li₂S—SiS₂—P₂S₅, Li₂S—SiS₂—Li₄SiO₄, Li₂S—SiS₂—Li₃PO₄, Li₃PS₄—Li₄GeS₄, Li_{3.4}P_{0.6}Si_{0.4}S₄, Li_{3.25}P_{0.25}Ge_{0.76}S₄ and Li₄₋ₓGe₁₋ₓPₓS₄.

Concrete examples of oxide solid electrolytes include LiPON (lithium phosphorus oxynitride) , Li_{1.3}Al_{0.3}Ti_{0.7}(PO₄)₃, La_{0.51}Li_{0.34}TiO_{0.74}, Li₃PO₄, Li₂SiO₂ and TA₂SiO₄.

In the case of the polymer electrolyte, it is preferable to appropriately select the polymer electrolyte, depending on the type of metal ions to be conducted. For example, the polymer electrolyte of lithium secondary batteries generally contains a lithium salt and a polymer. As the lithium salt, the above-mentioned inorganic lithium salts and/or the above-mentioned organic lithium salts can be used. The polymer is not particularly limited as long as it can form a complex with a lithium salt. As the polymer, for example, there may be mentioned polyethylene oxide.

### (Stack Unit)

The stack unit used in the present invention is a stack unit comprising at least the above-described positive electrode, electrolyte layer and negative electrode stacked together.

As described above, when a unit cell comprises two or more stack units, adjacent two of the stack units can share a part or all of the electrodes of the other. That is, the positive electrode of one stack unit can be the negative electrode of the other stack unit. Or, the positive electrode current collector of one stack unit can be the negative electrode current collector of the other stack unit.

When a unit cell comprises two stack units, and an electrode current collector is shared between the adjacent two stack units, a concrete example of stacking inside the unit cell is the following embodiment: a positive electrode current collector, a positive electrode active material layer, an electrolyte layer, a negative electrode active material layer, a current collector, a positive electrode active material layer, an electrolyte layer, a negative electrode active material layer and a negative electrode current collector.

When a unit cell comprises three stack units, and an electrode current collector is shared between adjacent two of the stack units, a concrete example of stacking inside the unit cell is the following embodiment: a positive electrode current collector, a positive electrode active material layer, an electrolyte layer, a negative electrode active material layer, a current collector, a positive electrode active material layer, an electrolyte layer, a negative electrode active material layer, a current collector, a positive electrode active material layer, an electrolyte layer, a negative electrode active material layer and a negative electrode current collector.

The number of the stack units can vary among the unit cells.

### (Cell Case)

The form of the cell case used in the present invention and the material for the same are not particularly limited, as long as the cell case can protect one or more stack units; the cell case has sealing properties that do not allow the fluid to enter; and the cell case is deformed mainly in ₜhe stacking direction of the components of each stack unit by applying pressure.

Concrete examples of the form of the cell case that can be used in the present invention, include a cylindrical form, a square form, a coin form and a laminate form.

Concrete examples of the material for the cell case that can be used in the present invention, include a metal can and a laminate. When the cell case is a laminaₜe-type cell case, there may be used a laminate film which is a three-layer film composed of polyethylene phthalate/aluminum/polyethylene.

### (Gap Member)

The gap member used in the present invention is not particularly limited, as long as it is a member that can form a space for the fluid to flow thereinto and to apply pressure to the stack units.

Concrete examples of the gap member include a porous body, a woven fabric, a non-woven fabric and a member having a groove.

The porous body is not particularly limited, as long as the pores are not collapsed when the fluid flows into the gap member. Concrete examples thereof include porous metals such as porous nickel, porous titanium and porous stainless-steel; porous ceramics such as porous alumina and porous silicon carbide; and porous resins such as porous urethane resin and porous polypropylene resin. Preferred are porous metals and porous ceramics, because they have sufficient strength and are flame-retardant.

The woven fabric is not particularly limited, as long as the regular spaces between the fibers of the fabric are not collapsed by the flowing fluid. Concrete examples thereof include a glass fiber fabric, a carbon fiber fabric, a Kevlar fabric and a metal fabric.

The non-woven fabric is not particularly limited, as long as the spaces between the irregularly tangled fibers of the fabric are not collapsed by the flowing fluid. Concrete examples thereof include a glass non-woven fabric, a carbon non-woven fabric and a metal non-woven fabric.

The member having a groove is not particularly limited, as long as it has at least a groove which has a strength that is enough to keep the shape even with the flow of the fluid. Concrete examples thereof include injection-molded products made of resins and molded wavy products made of metals, such as a press-molded product made of stainless-steel and a press-molded product made of titanium.

Of the porous body, the woven fabric, the non-woven fabric and the member having a groove, preferred is the porous body, from the point of view that the fluid can flow thereinto more easily and thus can apply uniform pressure to the electrodes.

The thickness of the gap member is not particularly limited, as long as it is a thickness that allows the fluid to sufficiently flow into the gap member. Although depending on the material, the thickness of the gap member is preferably about 0.1 to 1 mm.

### (Fluid)

The fluid that can be used in the present invention is not particularly limited, as long as it can be used to apply pressure. The fluid can be a gas or liquid. In the present invention, it is preferable that the fluid is pressurized to have a pressure equal to or more than the atmospheric pressure.

From the viewpoint of easy handing and supplying a sufficient amount, concrete examples of fluids that can be used in the present invention include gases such as nitrogen, argon, helium, air and carbon dioxide, and liquids such as silicone oil and fluorine oil. In the present invention, the fluid is preferably a gas.

In the case of using a gas to apply pressure, the pressure of the gas is preferably 0.1 to 10 MPa. When the pressure of the gas is less than 0.1 MPa, insufficient pressure may be applied to the stack units. On the other hand, when the pressure of the gas is more than 10 MPa, the cell case or housing cannot withstand the pressure and the battery module may break.

Especially when the battery module of the present invention is installed in a moving object such as a vehicle, the pressure of the gas is preferably set to 0.1 to 1.0 MPa, considering that an unexpected impact may be made on the battery module.

The method for supplying the fluid to the hermetically closed housing is not particularly limited, and known methods can be used. When the fluid used is a gas, the housing can be hermetically closed after the gas is supplied into the housing from a supply source such as a gas cylinder. Or, under an atmosphere consisting of the gas, the housing can be assembled and then hermetically closed as it is.

When the fluid used is a liquid, the housing can be hermetically closed after the liquid is supplied into the housing from a supply source such as a liquid-supply pump.

### (Housing)

The form of the housing used in the present invention and the material for the same are not particularly limited, as long as the housing can protect the unit cells and the gap members; the housing has sealing properties that do not allow the fluid to leak to the outside of the module; and the housing is not deformed by the filling of the fluid.

From the viewpoint of filling a sufficient amount of the fluid into the housing, the total volume of the unit cells and gap member(s) housed in the housing is preferably 85 to 99.5% of the capacity of the housing.

Concrete examples of the form of the housing that can be used in the present invention, include a cylindrical form, a square form and a coin form. Concrete examples of the material for the housing that can be used in the present invention, include stainless-steel, iron and aluminum.

### (Other Components)

Other components that can be used in the present invention include a separator. The separator is provided between the positive electrode and the negative electrode. In general, it functions to prevent contact between the positive electrode active material layer and the negative electrode active material layer and to retain the electrolyte layer. Examples of materials for the separator include resins such as polyethylene (PE), polypropylene (PP), polyester, cellulose and polyamide. Preferred are polyethylene and polypropylene. The separator can have a single- or multi-layer structure. Examples of the separator having a multi-layer structure include a separator having a two-layer structure of PE/PP and a separator having a three-layer structure of PP/PE/PP. Also in the present invention, the separator can be a non-woven fabric such as a resin non-woven fabric or a glass fiber non-woven fabric. The thickness of the separator is not particularly limited and is similar the thickness of separators that are used for general batteries.

### REFERENCE SIGNS LIST

1. Electrolyte layer

2. Positive electrode active material layer

3. Negative electrode active material layer

4 and 4a. Positive electrode current collector

5 and 5b. Negative electrode current collector

6 and 6a. Positive electrode

7 and 7b. Negative electrode

8, 8a and 8b. Stack unit

9. Cell case

10. Unit cell

11. Lead

12. Sealing material

13. Gap member

21. Housing

24. Positive electrode lead

25. Negative electrode lead

26. Sealing material

32. Double-headed arrow showing pressure directions applied by

a fluid

100. First typical example of the battery module according to the present invention

200. Second typical example of the battery module according to the present invention

300. Conventional battery module

1. A battery module comprising two or more unit cells and a hermetically closed housing for housing the two or more unit cells and a fluid, each unit cell comprising one or more stack units and a cell case for housing the one or more stack units, each stack unit comprising at least a positive electrode, an electrolyte layer and a negative electrode stacked together,
wherein the two or more unit cells are stacked in a direction that is substantially the same as a stacking direction of the one or more stack units and;
wherein a gap member is present between the stacked unit cells, the gap member being configured to allow the fluid to flow into the gap member and
wherein the fluid is a gas pressurized to have a pressure equal to or more than the atmospheric pressure.

2. The battery module according to claim 1, wherein the gap member is at least one selected from the group consisting of a porous body, a woven fabric, a non-woven fabric and a member having a groove.

3. The battery module according to claim 1, wherein the number of the stack units in each unit cell is one to three.

4. The battery module according to claim 1 wherein the gap member is a porous metal or a porous ceramic.

5. The battery module according to claim 1, wherein the pressure of the gas is 0.1 to 10 MPa.
